(19) United States
(12) Patent Application Publication
(10) Pub. No.: US 2007/0081788 A1
(43) Pub. Date: Apr. 12, 2007

(54) Display apparatus and control method thereof

(75) Inventors: Sung-youn Park, Suwon-si (KR); Young-hwa Yun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/541,649

(22) Filed: Oct. 3, 2006

(30) Foreign Application Priority Data
Oct. 8, 2005 (KR) 10-2005-0094671

(51) Int. Cl. H04N 5/91

(52) U.S. Cl. 386/83

(57) ABSTRACT

A display apparatus having a digital record function and a method thereof. The display apparatus includes a broadcasting program memory in which a broadcasting program is stored; an up/down reproduction selecting part for selecting reproduction of the broadcasting program stored in the broadcasting program memory; and a controller for controlling the signal processing part to process the broadcasting program corresponding to selection of the up/down reproduction selecting part and display the processed broadcasting program on the display according to a stored temporal order of the stored broadcasting programs.

### CROSS-REFERENCE TO RELATED APPLICATIONS

This application claims priority from Korean Patent Application No. 10-2005-0094671, filed on Oct. 8, 2005, in the Korean Intellectual Property Office, the disclosure of which is incorporated herein by reference in its entirety.

### BACKGROUND OF THE INVENTION

1. Field of the Invention

Methods an apparatuses consistent with the present invention relate to a display apparatus having a digital record function.

2. Description of the Related Art

A digital record function, for example, a Personal Video Recorder (PVR) function, records received broadcasting signals in a memory provided in a display apparatus as digital signals, and reproduces the digital signals from the memory. The PVR function may be incorporated into the display apparatus or incorporated into set-top boxes connected to the display apparatus. A user may record desired broadcasting programs using the PVR function without using separate tapes.

For example, when the user selects a record function while he watches television, the display apparatus stores a broadcasting signal of a currently televising broadcasting program in a memory as a digital signal, and the user may select and reproduce a desired one of broadcasting programs stored in the memory.

In this case, in order to reproduce the desired broadcasting program, it must be selected from a list of the stored broadcasting programs. If broadcasting programs in the list are represented by file names and the user does not know a file name of the desired broadcasting program, it is inconvenient for the user to reproduce and confirm all of the stored broadcasting programs one by one.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

According to an aspect of the invention, there is provided a display apparatus which is capable of improving accessibility of users by preparing channel selection buttons and reproduction selection buttons as top/bottom/left/right buttons to reproduce broadcasting programs stored in a broadcasting program memory in a way similar to a way that a channel of a currently televising broadcasting program is switched, and a control method thereof.

According to another aspect of the invention, there is provided a display apparatus is which is capable of improving a user's convenience by facilitating reproduction of broadcasting programs stored in a broadcasting program memory while a user is watching a broadcasting program, and a control method thereof.

According to an exemplary embodiment of the invention, there is provided a display apparatus comprising a signal receiving part for receiving a broadcasting signal, a signal processing part for processing the received broadcasting signal, and a display, comprising: a broadcasting program memory in which a broadcasting program is stored; an up/down reproduction selecting part for selecting reproduction of the broadcasting program stored in the broadcasting program memory; and a controller for controlling the signal processing part to process the broadcasting program corresponding to selection of the up/down reproduction selecting part and display the processed broadcasting program on the display according to stored temporal order of the stored broadcasting programs.

According to another exemplary embodiment of the present invention, the controller causes to switch to the broadcasting program corresponding to selection of the up/down reproduction selecting part selected according to the stored temporal order of the stored broadcasting programs while a broadcasting signal received from the signal receiving part is being displayed.

According to yet another embodiment of the present invention, the up/down reproduction selecting part comprises reproduction up/down keys for selection of the broadcasting program to be reproduced.

According to yet another exemplary embodiment of the present invention, the display apparatus further comprises a user selecting part having top/bottom/left/right buttons, wherein the reproduction up/down keys are prepared as the left/right buttons of the user selecting part.

Further, according to another exemplary embodiment of the present invention, the display apparatus further comprises a channel selecting part having channel up/down keys for selection of a channel of the broadcasting program, wherein the channel up/down keys are prepared as the top/bottom buttons of the user selecting part.

According to yet another embodiment of the present invention, the controller controls the signal processing part to receive the broadcasting signal corresponding to a selected channel and display the received broadcasting signal on the display when the channel up/down keys are selected, and controls the signal processing part to display the broadcasting program stored in the broadcasting program memory on the display when the reproduction up/down keys are selected while the received broadcasting signal is being displayed.

According to yet another exemplary embodiment of the present invention, the controller causes to reproduce the broadcasting program stored next to the lastly reproduced broadcasting program according to the stored temporal order of the stored broadcasting programs when the reproduction up key is selected.

According to an exemplary embodiment of the present invention, the controller causes to reproduce the broadcasting program stored prior to the lastly reproduced broadcasting program when the reproduction down key is selected.

According to another aspect of the invention, there is provided a control method of a display apparatus comprising a signal receiving part for receiving a broadcasting signal, a signal processing part for processing the received broadcasting signal, a broadcasting program memory in which a broadcasting program is stored, an up/down reproduction selecting part for selecting reproduction of the broadcasting program stored in the broadcasting program memory, and a display, comprising: displaying the broadcasting program received from the signal receiving part on the display; selecting the up/down reproduction selecting part; and by the signal processing part, processing the broadcasting program corresponding to the selection of the up/down reproduction selecting part and displaying the processed broadcasting program on the display according to stored temporal order of the stored broadcasting programs.

According to an exemplary embodiment of the present invention, the up/down reproduction selecting part comprises reproduction up/down keys for selection of the broadcasting program to be reproduced.

According to another exemplary embodiment of the present invention, the display apparatus further comprises a user selecting part having top/bottom/left/right buttons, wherein the reproduction up/down keys are prepared as the left/right buttons of the user selecting part.

According to yet another exemplary embodiment of the present invention, the display apparatus further comprises a channel selecting part having channel up/down keys for selection of a channel of the broadcasting program, wherein the channel up/down keys are prepared as the top/bottom buttons of the user selecting part.

According to yet another exemplary embodiment of the present invention, the control method further comprises controlling the signal processing part to receive the broadcasting signal corresponding to a selected channel and displays the received broadcasting signal on the display when the channel up/down keys are selected, and to display the broadcasting program stored in the broadcasting program memory on the display when the reproduction up/down keys are selected while the received broadcasting signal is being displayed.

According to an exemplary embodiment of the present invention, the broadcasting program stored next to the lastly reproduced broadcasting program is reproduced according to the stored temporal order of the stored broadcasting programs when the reproduction up key is selected.

According to another exemplary embodiment of the present invention, the broadcasting program stored prior to the lastly reproduced broadcasting program is reproduced when the reproduction down key is selected.

### BRIEF DESCRIPTION OF THE DRAWINGS

The above and other aspects of the present invention will become apparent and more readily appreciated from the following description of the exemplary embodiments, taken in conjunction with the accompanying drawings of which:

FIG. 1 is a control block diagram of a display apparatus according to an exemplary embodiment of the present invention;

FIG. 2 is a front view of a user selecting part according to an exemplary embodiment of the present invention; and

FIG. 3 is a control flow chart illustrating a control process of the display apparatus according to an exemplary embodiment of the present invention.

### DETAILED DESCRIPTION OF EXEMPLARY EMBODIMENTS OF THE EMBODIMENT

Reference will now be made in detail to exemplary embodiments of the present invention, examples of which are illustrated in the accompanying drawings.

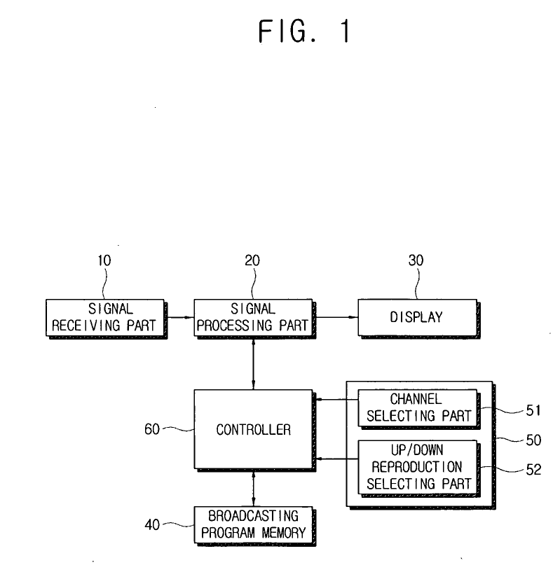

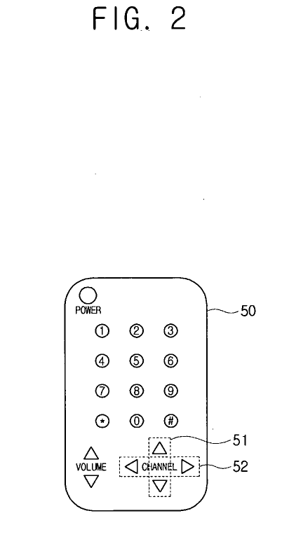

FIG. 1 is a control block diagram of a display apparatus according to an exemplary embodiment of the present invention, and FIG. 2 is a front view of a user selecting part according to an exemplary embodiment of the present invention.

As shown in FIG. 1, a display apparatus includes a signal receiving part 10, a signal processing part 20, a display 30, a broadcasting program memory 40, a user selecting part 50, and a controller 60.

The signal receiving part 10 includes a tuner (not shown) for receiving broadcasting signals. The broadcasting signal received in the tuner (not shown) is displayed on the display 30 through a process in the signal processing part 20. Here, the display 30 may be implemented with various types such as a DLP (Digital Light Processing), an LCD (Liquid Crystal Display), a PDP (Plasma Display Panel), or the like and the signal processing part 20 may include a scaler (not shown) for scaling the broadcasting signals in accordance with an output format of the display 30, for example, a vertical frequency, resolution, picture ratio, etc.

The broadcasting program memory 40 stores broadcasting programs and may be implemented by a Flash Memory, a Hard Disk, an EEPROM (Electrically Erasable Programmable Read-Only Memory), an EPROM (Erasable Programmable Read-Only Memory), etc.

Here, if a received broadcasting program is an analog broadcasting signal, it is converted into a digital signal and then stored in the broadcasting-program memory 40. At the same time, an order of broadcasting program stored time according to the date and hour in which the broadcasting programs are stored in the broadcasting program memory 40 may be also stored together.

The user selecting part 50 includes keys and the like for selecting channels of the broadcasting programs. In addition, the user selecting part 50 may further include menu keys provided in a remote controller or a casing of the display apparatus, and a key signal generating part for generating a key signal corresponding to a key operation.

Here, as shown in FIG. 2, the user selecting part 50 in this embodiment includes a channel selecting part 51 having channel up/down keys for selecting a channel of a received broadcasting program, i.e., a currently televising broadcasting program, and an up/down reproduction selecting part 52 for selecting reproduction of broadcasting programs stored in the broadcasting program memory 40. Here, the up/down reproduction selecting part 52 has reproduction up/down keys for selecting a broadcasting program to be reproduced.

In addition, the channel up/down keys of the channel selecting part 51 and the reproduction up/down keys of the reproduction selecting part 52 may be grouped. In this case, for example, the channel up/down keys of the channel selecting part 51 may be set in a vertical direction and the reproduction up/down keys of the reproduction selecting part 52 may be set in a horizontal direction.

For example, when a user selects a channel up key of the channel selecting part 51 while he is watching a broadcasting program corresponding to Channel No. 7, he can watch a broadcasting program corresponding to Channel No. 8. In addition, if broadcasting programs are stored in the broadcasting program memory 40, when the user selects one of the reproduction up/down keys of the up/down reproduction selecting part 52 while he is watching the broadcasting program corresponding to Channel No. 8, a broadcasting program stored in the broadcasting program memory 40 is reproduced corresponding to the selected key. Here, the user may select broadcasting programs stored prior to or next to the reproduced broadcasting program using the reproduction up/down keys of the up/down reproduction selecting part 52.

In addition, the user selecting part 50 may include a record key by means of which the user may record a currently televising broadcasting program. Also, a display apparatus that receives EPG (Electronic Programming Guide) information may record broadcasting programs using the EPG information.

When the up/down reproduction selecting part 52 is selected while the user is watching a broadcasting program received through the signal receiving part 10, the controller 60, which may be implemented by a CPU, a microcomputer or the like, controls a broadcasting program stored in the broadcasting program memory 40 to be reproduced.

More specifically, when one of the channel up/down keys of the channel selecting part 51 provided in the user selecting part 51 is selected, the controller 60 switches a channel of the broadcasting program received through the signal receiving part 10, i.e., a channel of a currently televising broadcasting program, according to a selected key. In addition, when one of the reproduction up/down keys of the reproduction selecting part 52 is selected while the user is watching the currently televising broadcasting program, the controller 60 reproduces, a broadcasting program stored in the broadcasting program memory 40, so that the user may make an easy access to the stored broadcasting program.

In this case, if the reproduction up key of the up/down reproduction selecting part 52 is selected, the controller 60 reproduces a broadcasting program stored next to the lastly reproduced broadcasting program according to a stored temporal order of broadcasting programs stored in the broadcasting program memory 40. In addition, if the reproduction down key is selected, the controller 60 reproduces a broadcasting program stored prior to the lastly reproduced broadcasting program.

In addition, if the reproduction up key of the up/down reproduction selecting part 52 is selected while the latest or lastly stored broadcasting program is being reproduced, the controller 60 reproduces the earliest stored broadcasting program. Similarly, if the reproduction down key of the up/down reproduction selecting part 52 is selected while the earliest or oldest stored broadcasting program is being reproduced, the controller 60 reproduces the lastly stored broadcasting program.

Further, when the record key provided in the user selecting part 50 is selected, the controller 60 stores the currently televising broadcasting program in the broadcasting program memory 40. In case of a display apparatus that receives the EPG information, the controller 60 stores a broadcasting program reserved for recording in the broadcasting program memory 40. For example, when the user selects a reservation record of broadcasting programs, the controller 60 stores reservation information, such as start time and end time of broadcasting programs reserved using the EPG information, in a predetermined memory (not shown), and stores the broadcasting programs in the broadcasting program memory 40 based on the stored reservation information.

In addition, when the channel selecting part 51 is selected while a stored broadcasting program is being reproduced, the controller 60 displays the currently televising broadcasting program on a screen and switches a channel of the broadcasting program in response to the channel up/down keys of the selected channel selecting part 51.

For example, assuming that broadcasting programs recorded at 14:00 on October 2, 17:00 on October 2, 09:00 on October 3, and 10:00 on October 4 are stored in the broadcasting program memory 40 and the lastly reproduced broadcasting program of the stored broadcasting programs is the broadcasting program recorded at 17:00 on October 2.

If a channel number of a broadcasting program being now watched is 9, when the user selects the down key of the channel selecting part 51, a broadcasting program corresponding to channel No. 8 is displayed. In addition, when the user selects the reproduction down key of the up/down reproduction selecting part 52 while he is watching the broadcasting program corresponding to channel No. 8, a broadcasting program recorded at 14:00 on October 2, which is stored before 17:00 on October 2, is reproduced. In addition, when the user selects the down key of the up/down reproduction selecting part 52 again, the lastly stored broadcasting program recorded at 10:00 on October 4 is reproduced since there is no broadcasting program stored before 14:00 on October 2.

In this way, while watching the currently televising broadcasting program, the user may immediately reproduce the broadcasting programs stored in the broadcasting program memory 40 using the up/down reproduction selecting part 52.

If there is no broadcasting program stored in the broadcasting program memory 40, the controller 60 continues to display the currently televising broadcasting program even if the up/down reproduction part 52 is selected.

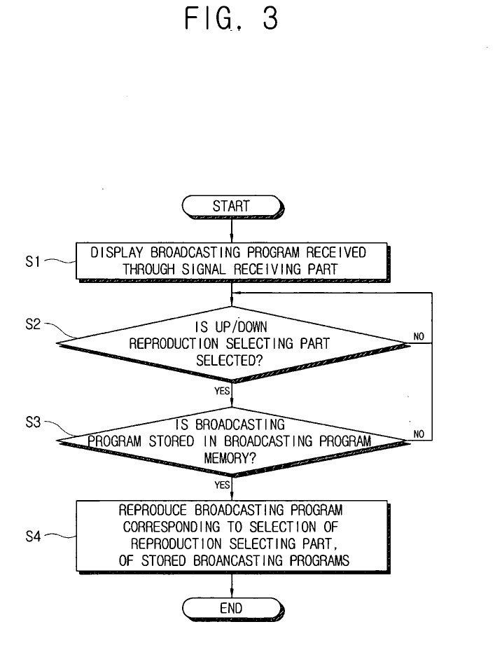

A control method according to an exemplary embodiment of the present invention will now be described with reference to the flow chart of FIG. 3.

As shown in FIG. 3, the display apparatus displays a broadcasting program received through the signal receiving part 10 at operation S1.

Then, when the up/down reproduction selecting part 52 is selected at operation S2, the controller 60 confirms whether or not broadcasting programs are stored in the broadcasting program memory 40 at operation S3, and reproduces a broadcasting program in response to the selected up/down reproduction selecting part 52, of the stored broadcasting programs at operation S4.

When one of the, reproduction up/down keys included in the up/down reproduction selecting part 52 is selected, the controller 60 reproduces the broadcasting programs stored in the broadcasting program memory 40. Here, if the reproduction up key is selected, the controller 60 reproduces a broadcasting program stored next to the lastly reproduced broadcasting program. In addition, if the reproduction down key is selected, the controller 60 reproduces a broadcasting program stored prior to the lastly reproduced broadcasting program.

In this way, the user can select and reproduce stored broadcasting programs without difficulty while he is watching the currently televising broadcasting program.

As apparent from the description, the present invention provides a display apparatus which is capable of improving accessibility of users by preparing channel selection buttons and reproduction selection buttons as top/bottom/left/right buttons to reproduce broadcasting programs stored in a broadcasting program memory in a way similar to a way to switch a channel of a currently televising broadcasting program, and a control method thereof.

In addition, the present invention provides a display apparatus which is capable of improving user's convenience by facilitating reproduction of broadcasting programs stored in a broadcasting program memory while a user is watching a broadcasting program, and a control method thereof.

Although ,exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a signal receiving part that receives a broadcasting signal;
a signal processing part that processes the received broadcasting signal;
a display;
a broadcasting program memory that stores a broadcasting program;
an up/down reproduction selecting part that selects a reproduction of the broadcasting program stored in the broadcasting program memory; and
a controller that controls the signal processing part to process the broadcasting program corresponding to selection of the up/down reproduction selecting part according to a stored temporal order of the stored broadcasting programs and display the processed broadcasting program on the display.

2. The display apparatus according to claim 1, wherein the controller switches to the broadcasting program corresponding to selection of the up/down reproduction selecting part selected according to the stored temporal order of the stored broadcasting programs while a broadcasting signal received from the signal receiving part is being displayed.

3. The display apparatus according to claim 1, wherein the up/down reproduction selecting part comprises reproduction up and down keys for selection of the broadcasting program to be reproduced.

4. The display apparatus according to claim 3, further comprising a user selecting part having top, bottom, left, and right buttons,
wherein the reproduction up/down keys are prepared as the left and right buttons, respectively of the user selecting part.

5. The display apparatus according to claim 4, further comprising a channel selecting part having channel up/down keys for selection of a channel of the broadcasting program,
wherein the channel up/down keys are prepared as the top and bottom buttons, respectively of the user selecting part.

6. The display apparatus according to claim 5, wherein the controller controls the signal processing part to receive the broadcasting signal corresponding to a selected channel and display the received broadcasting signal on the display when the channel up/down keys are selected, and controls the signal processing part to display the broadcasting program stored in the broadcasting program memory on the display when the reproduction up/down keys are selected.

7. The display apparatus according to claim 6, wherein the controller causes to reproduce the broadcasting program stored next to a lastly reproduced broadcasting program according to the stored temporal order of the stored broadcasting programs when the reproduction up key is selected.

8. The display apparatus according to claim 6, wherein the controller causes to reproduce the broadcasting program stored prior to the lastly reproduced broadcasting program when the reproduction down key is selected.

9. A control method of a display apparatus, the display apparatus comprising a signal receiving part that receives a broadcasting signal, a signal processing part that processes the received broadcasting signal, a broadcasting program memory that stores a broadcasting program, an up/down reproduction selecting part that selects reproduction of the broadcasting program stored in the broadcasting program memory, and a display, the method comprising:
displaying the broadcasting program received from the signal receiving part on the display;
selecting the up/down reproduction selecting part; and
by the signal processing part, processing the broadcasting program corresponding to the selection of the up/down reproduction selecting part according to a stored temporal order of the stored broadcasting programs and displaying the processed broadcasting program on the display.

10. The control method according to claim 9, wherein the up/down reproduction selecting part comprises reproduction up and down keys for selection of the broadcasting program to be reproduced.

11. The control method according to claim 10, wherein the display apparatus further comprises a user selecting part having top, bottom, left, and right buttons,
wherein the reproduction up/down keys are prepared as the left and right buttons, respectively of the user selecting part.

12. The control method according to claim 11, wherein the display apparatus further comprises a channel selecting part having channel up/down keys for selection of a channel of the broadcasting program,
wherein the channel up/down keys are prepared as the top and bottom buttons, respectively of the user selecting part.

13. The control method according to claim 12, further comprising controlling the signal processing part to receive the broadcasting signal corresponding to a selected channel and displaying the received broadcasting signal on the display when the channel up/down keys are selected, and displaying the broadcasting program stored in the broadcasting program memory on the display when the reproduction up/down keys are selected.

14. The control method according to claim 13, wherein the broadcasting program stored next to a lastly reproduced broadcasting program is reproduced according to the stored temporal order of the stored broadcasting programs when the reproduction up key is selected.

15. The control method according to claim 13, wherein the broadcasting program stored prior to the lastly reproduced broadcasting program is reproduced when the reproduction down key is selected.
